(19) United States
(12) Patent Application Publication
(10) Pub. No.: US 2006/0113153 A1
(43) Pub. Date: Jun. 1, 2006

(54) Brake disc assembly

(76) Inventor: Jonathan James Simmonds, Warwickshire (GB)

Correspondence Address: Andrew R Basile, Sr;Young & Basile, 3001 W Big Beaver Road, Suite 624, Troy, MI, 48084, US

(21) Appl. No.: 10/542,526

(22) PCT Filed: Jan. 15, 2004
(86) PCT No.: PCT/GB04/00131

§ 371 Date: Jul. 15, 2005

(30) Foreign Application Priority Data
Jan. 16, 2003 (GB) 0300983.4

(51) Int. Cl. F16D 65/12

(52) U.S. Cl. 188/218 XL

(57) ABSTRACT

A floating brake disc assembly (10) has a hub member (14) and a rotor (12) mounted to the hub member for rotation therewith, the rotor being capable of moving in an axial direction of the disc relative to the hub member to a limited extent. A number of drive members (38) are rigidly attached to the rotor for engagement in corresponding cutouts (36) in the hub member, the drive members being movable in an axial direction of the disc relative to the cutouts as the rotor moves axially relative to the hub member. The axial movement of the rotor relative to the hub member is limited by corresponding stop means (26, 34a; 46, 34B) associated with the rotor and the hub member respectively. A friction means (60) is provided to resist, at least initially, axial movement of at least one of the drive members relative to its corresponding cutout. The friction means introduces a predetermined level of hysteresis into the floating disc mechanism to reduce rattle and vibration.

The present invention relates to a brake disc assembly. In particular, the present invention relates to a brake disc assembly of the floating type in which a brake rotor is mounted to a hub member in a manner which allows the rotor to move axially relative to the hub member to a limited amount, whilst being constrained to rotate with the hub member.

It is known to provide a brake disc assembly in which a brake rotor is rigidly mounted to a hub member. For use with standard production vehicles, the brake rotor and hub are often produced as a one piece component. For higher performance vehicles, it is known to produce a brake disc assembly having a brake rotor that is rigidly attached to the hub, either by means of bolts or rivets.

It is also known to provide a brake disc assembly of the floating type, in which the rotor is mounted to the hub member so that it can move axially relative to the hub member to a limited extent. Floating disc assemblies offer a number of advantages over brake disc assemblies in which the rotor is rigidly connected to the hub member. These include:
improved thermal stability as a result of removing the radial constraint present in any rigidly mounted brake rotor, this leads to a reduction in coning;
reduced tendency for build up of disc thickness variation (DTV) as axial movement of rotor relative to hub effectively eliminates run-out of the rotor relative to the hub;
reduced transmission of vibration created at the interface of rotor and pad;
resistence to cracking which can be caused by stresses induced in a rigidly mounted disc rotor by thermal variations.

These and other advantages of floating type brake disc assemblies are well known in the art.

It is also known to provide floating brake disc assemblies in which the rotor is connected to the hub member by means of a number of circumferentially spaced, axially extending bobbins or drive members. In one known arrangement, the rotor is rigidly attached to the bobbins which are received in cutouts or recesses in the hub member. The bobbins are capable of limited axial movement relative to the cutouts and have radially extending, circumferential end faces that engage with opposing radial faces of the cutouts to transmit torque between the rotor and the hub member.

The above known arrangement has been used extensively for high performance racing vehicles. However, the arrangement has not been found to be suitable for vehicles intended for general road use. This is because movement of the rotor relative to the hub can lead to rattle and/or vibration caused by contact between the stops used to limit the axial movement of the rotor relative to the hub. Whilst such rattle and vibration can be tolerated in a racing vehicle, it is not acceptable in a general road going vehicle and is particularly unacceptable in respect of high value, high performance vehicles where correspondingly high levels of refinement are expected.

In an attempt to reduce the rattle and vibration in a floating type brake disc assembly to acceptable limits, it is known to use a spring means to provide an axial pre-load between the rotor and the hub member. EP 1 094 229, for example, shows a brake disc assembly in which the rotor is connected to a hub member by a plurality of rivets that engage in opposing semi-circular recesses in the rotor and the hub. A conical spring is located between an end flange of each rivet and the rotor and hub. Whilst this arrangement helps to reduce rattle and vibration, it is not ideal as it results in a reduction in the efficiency of the floating rotor arrangement. This is because the axial pre-load, whilst relatively light, nevertheless may prevent the rotor from adopting an optimal axial position with regard to the hub member. As a result there is a risk of inducing DTV as the axial position of the floating rotor will to some extent be influenced by the run-out of the assembly.

There is then a need for an improved floating type brake disc assembly in which the above problems are obviated or at least substantially reduced.

In particular there is a need for a floating type brake disc assembly in which rattle and vibration are reduced without unduly reducing the efficiency of the floating rotor assembly.

In accordance with the invention, there is provided a brake disc assembly comprising a hub member and a rotor mounted to the hub member for rotation therewith, the rotor being capable of moving in an axial direction of the disc assembly relative to the hub member to a limited extent, at least one drive member rigidly attached to one of the rotor or the hub member and being received in a corresponding cutout in the other of the rotor or the hub member, the drive member being movable in an axial direction of the disc assembly relative to the cutout as the rotor moves axially relative to the hub member, the drive member having radially extending faces for contact with opposing faces of the corresponding cutout to transmit torque between the rotor and the hub member, characterised in that said axial movement of the rotor relative to the hub member is limited by corresponding stop means associated with the rotor and the hub member respectively and in that a friction means is provided to resist, at least initially, axial movement of the drive member relative to its corresponding cutout.

The provision of a friction means operative between the drive member and its cutout introduces hysteresis into the mechanism. The level of hysteresis is selected or pre-determined so that it reduces rattle and vibration to acceptable levels without significantly reducing the efficiency of the floating rotor arrangement. A particular advantage of the brake disc assembly in accordance with the invention is that no axial pre-load is applied between the rotor and the hub member.

Preferably, the friction means is operative between at least one of the radially extending faces of the drive member and an opposing face of the cutout. More preferably, the friction means is operative between a radially extending face of the drive member and an opposing face of the cutout which are adapted, in use, to transmit breaking forces between the rotor and the hub when the disc assembly is braked whilst rotating in a forward direction. In one embodiment, the friction means is operative between a normally leading face of the drive member and an opposing face of the cutout.

Preferably, the friction means comprises a resilient means which may be in the form of a spring clip.

Preferably, the resilient means is at least partially received in a recess formed in one of a radially extending face of the drive member or an opposing face of the cutout and is adapted to contact the other of said radially extending face or said opposing face.

Preferably, the resilient means is at least partially received in a recess formed in a radially extending face of the drive member.

Preferably, the resilient means can be compressed into the recess to enable direct contact between said radially extending face and said opposing face when braking forces are transferred from the rotor to the hub member through said faces.

Preferably, the recess is curved.

Advantageously, where the resilient means is a spring clip, the clip can be generally D-shaped in cross section, the curved portion being received in the recess. The spring clip may be split at the apex of the D.

Preferably, the resilient means applies a pre-load acting in the direction of the applied braking force when the disc assembly is braked whilst rotating in a forward direction in use.

Preferably, there are a plurality of circumferentially spaced drive members, a friction means being provided in respect of at least one of the drive members. More preferably, the number of friction means provided on the disc assembly is selected such that the overall level of hysteresis introduced into the floating rotor mechanism is adapted to suit the particular application.

Preferably, the friction means is arranged to provided a pre-determined level of friction between the drive member and the cutout.

An embodiment of the invention will now be described, by way of example only, with reference to the accompanying drawings in which:

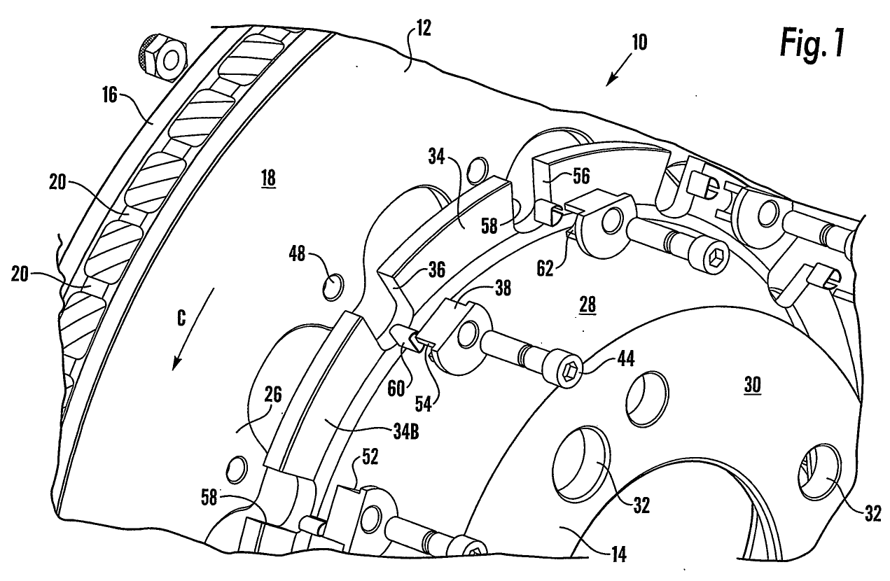

FIG. 1 is a perspective, exploded view of part of a brake disc assembly in accordance with the invention;

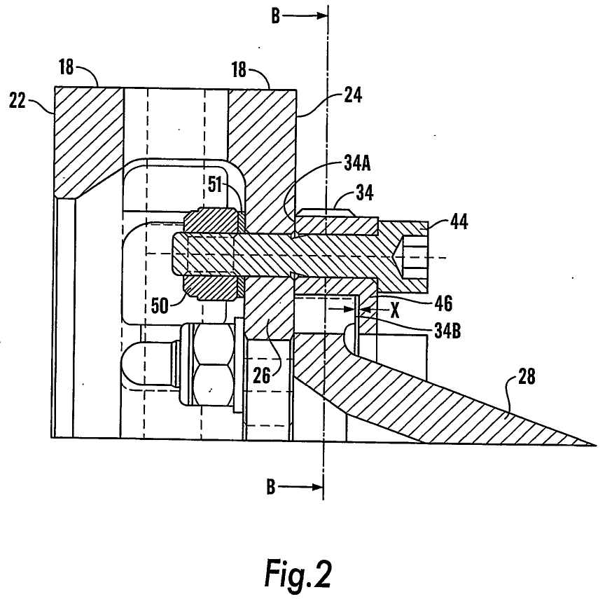

FIG. 2 is a cross sectional view through part of the brake disc assembly of FIG. 1 in an assembled condition;

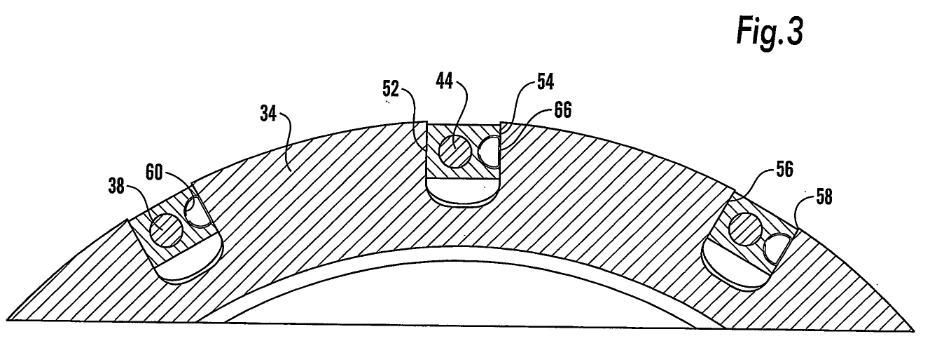

FIG. 3 is a cross sectional view through part of the brake disc assembly of FIGS. 1 and 2 taken on line B-B of FIG. 2; and

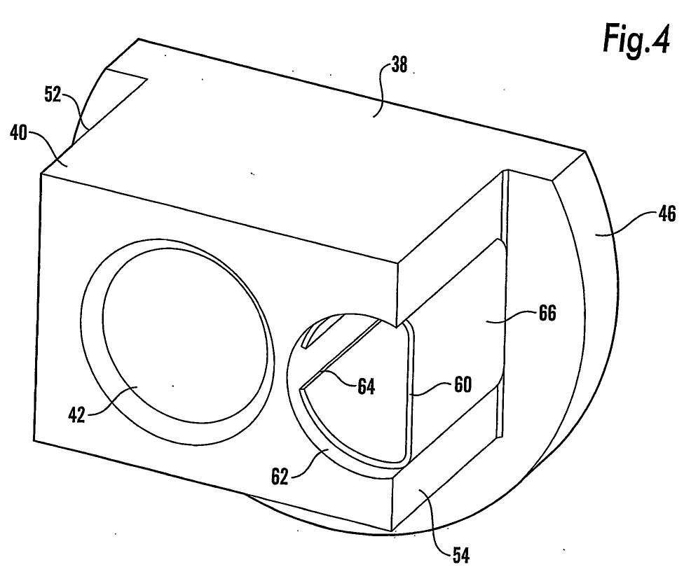

FIG. 4 is a perspective view of a drive member or bobbin forming part of the brake disc assembly of FIGS. 1 to 3.

With reference to the drawings, a brake disc assembly 10 in accordance with the invention comprises a rotor 12 and a hub member 14. The rotor 12 and the hub member 14 can be made of any suitable material for example cast iron, steel, aluminium, or carbon. If required, the rotor 12 and hub member 14 can be made of different materials.

The rotor 12 has two generally annular discs of material 16, 18 joined by a plurality of vanes 20 to provide an air gap between the discs through which cooling air can circulate. This arrangement is well known in the art, being referred to as a ventilated rotor. Each of the discs 16, 18 has an outer surface 22, 24 for contact with a brake pad in a known manner. One of the discs 18 has a number of mounting lugs 26 that project radially inwardly from its inner circumference for mounting the rotor to the hub member 14, as will be described in more detail below.

Whilst it is preferred that rotor 12 is a ventilated rotor, it should be understood that the invention can be applied equally to a disc assembly having a solid or non-ventilated rotor.

The hub member 14 is of the type commonly referred to in the art as a “mounting bell” and has a generally axially extending body portion 28. A first radial flange 30 projects inwardly from one end of the axial body portion 28 and has a number of holes 32 by which the hub member can be mounted to a hub (not shown) of a vehicle in proximity with a wheel (also not shown). The hub member 14 has a second radial flange 34 that projects outwardly from the other end of the generally axially extending body portion 28. A number of circumferentially spaced cutouts 36 are provided in second radial flange 34. The number and position of the cutouts corresponding to the number and position of the mounting lugs 26 on the rotor 12.

The geometry of the mounting bell is unrelated to the function of the invention. Thus depending on the application, the hub member may comprise a mounting bell that is offset inboard or outboard or may even be flat.

The cutouts 36 are generally “U” shaped and are adapted to receive drive members or bobbins 38 for connecting the rotor 12 to the hub member 14. As can be seen best from FIG. 4, each bobbin 38 has a main body potion 40 that is generally rectangular in cross section. The main body portion 40 is received in a respective cutout 36 with a small clearance fit in the circumferential direction. A hole 42 is provided through the centre of the bobbin though which a bolt 44 can pass for attaching the bobbin to a respective mounting lug 26 of the rotor 12. A part circular radial flange 46 is provided at one end of the main body portion 40 and is sized so as to extend beyond the edges of a respective cutout 36.

Mounting of the rotor 14 to the hub member 12 can be best seen in FIG. 2. A bobbin 38 is located in each of the cutouts 36 so that the part circular flanges 46 overlie the second radial flange 34 of the hub member on the side which is outermost in use. The rotor 12 is positioned so that the mounting lugs 26 are aligned with the opposites ends of the bobbins 38 from the part circular flanges 46 and bolts 44 are inserted through the holes 42 in the bobbins and through corresponding holes 48 in the mounting lugs 28. Nuts 50 are fitted to the bolts 44 and tightened to rigidly attach the rotor 12 to the bobbins 38. Washers 51 may be positioned between the nuts 50 and the mounting lugs 26 as required.

Whilst in the preferred embodiment the bobbins 38 are attached to their respective mounting lugs 28 by means of a nut and bolt, this is not essential and it will be appreciated that any suitable fastening method can be used. For example, the bobbins 38 can be attached to the mounting lugs 26 by means of rivets or any other suitable fastener.

The direction of rotation of the brake disc assembly 10 when it is fitted to a vehicle that is travelling forwardly is indicated in FIG. 1 by the arrow C, this will be referred to as the “forward direction” of rotation of the disc. The main body portion 40 of each bobbin 38 has first and second radially extending circumferential end faces 52, 54. As can be seen, the first circumferential end face 52 of each bobbin will be the trailing face when the disc is rotated in the forward direction of rotation. This face will be referred to as the normally trailing face 52. The second end face 54 will be referred to as the normally leading face 54.

In order to brake an associated vehicle to which the disc 10 is fitted, a braking force is applied to the rotor 12 by means of a brake caliper (not shown) which biases brake pads (also not shown) into contact with the outer faces 22, 24 of the rotor 12 in a manner well known in the art. When the associated vehicle is travelling forwardly, the disc assembly will be rotated in the forward direction of rotation C as previously described. If a braking force is applied to the rotor 12 with the disc rotating in the forward direction, the normally trailing faces 52 of the bobbins will contact the opposing radial faces 56 of their respective cutouts 36, to transmit braking forces from the rotor 12 to the hub member 14.

When a vehicle to which the disc assembly 10 is fitted is travelling in the reverse direction, the disc assembly will be rotated in the direction opposite to arrow C, which will be referred to herein as the “reverse direction” of rotation of the disc assembly, in which case the normally trailing face 52 of the bobbing will become the leading face. When a braking force is applied to the rotor 12 of a disc assembly rotating in the reverse direction, the normally leading faces 54 of the bobbins will contact their opposing radial faces 58 of the cutouts to transmit braking forces from the rotor 12 to the hub member 14.

With the rotor 12 mounted to the hub member 14 as described above, axial movement of the rotor relative to the hub member is limited by contact between the rotor mounting lugs 26 and the inner face 34A of the second radial flange 34 of the hub member, and by contact between the part circular bobbin flanges 46 and the outer face 34B of the second radial flange 34. Thus the mounting lugs 26 and inner face 34A of the second radial flange act as corresponding stops associated with the rotor and hub member respectively to limit the axial movement of the rotor relative to the hub member in a first axial direction, whilst the bobbin flanges 46 and the outer face 34B of the second radial flange act as corresponding stops associated with the rotor and hub member respectively to limit axial movement of the rotor relative to the hub in the opposite axial direction.

The axial length of the main body portion 40 of the bobbins is slightly larger than the axial thickness of the second radial flange 34 so that there is a small axial clearance or float X between the part circular flanges 46 on the bobbins and the outer face 34B of the second radial flange. This clearance X enables the bobbins 38 to move in the direction of the axis of rotation of the brake disc assembly to a limited extent and so allows the rotor 12 to float axially relative to the hub member 14.

To control the axial movement of the rotor 12 relative to the hub member 14 and to reduce unwanted vibration and/or rattle, a friction means is provided in association with each of the bobbins 38 and which act between the bobbins 38 and their respective cutouts 36. In the preferred embodiment the friction means is in the form of a spring clip 60 located in a part circular or curved recess 62 formed in the normally leading face 54 of the main body portion 40 of each bobbin. The spring clips 60 are generally “D” shaped in cross section with a split at the apex of the D as indicated at 64. As can be seen best from FIG. 4, when a spring clip 60 is fitted into the recess 62 of a bobbin, the flat face portion 66 of the clip projects slightly beyond the normally leading face 54. The arrangement is such that when a bobbin is inserted into its respective cutout, the flat face portion 66 the spring clip is biassed into contact with the opposing face 58 of the cutout. Frictional contact between the spring clip 60 and the opposing face 58 resists, at least initially, axial movement of bobbin in the cutout and so introduces hysteresis into the system.

Although the disc assembly 10 of the present embodiment comprises a spring clip 60 or friction means in respect of each of the bobbins 38, this is not necessarily the case and a spring clip 60, or other friction means, may be provided in respect of only some or even only one of the bobbins or drive members 38 as will be discussed in more detail later.

The level of the friction force generated by the spring clips 60 is selected or pre-determined within acceptable limits so that it is sufficient to prevent or reduce unwanted movement of the rotor, which might result in rattling or vibration, but is not so high that it significantly reduces the efficiency of the floating mechanism, preventing the rotor 12 moving axially relative to the hub member 14 to compensate for runout in the assembly. A particular advantage of the spring clips 60 of the present invention when compared to the prior art is that the pre-load of the clips acts circumferentially rather than axially and so does not unduly influence the axial alignment of the rotor 12 relative to the hub 14.

As described earlier, during forward travel of an associated vehicle to which the brake disc assembly 10 is fitted, braking forces are transmitted from the rotor 12 to the hub member 14 through the normally trailing faces 52 of the bobbins 38 and the opposing faces 56 of the cutouts. Since most braking will occur during forward travel, it is preferred that the spring clips 60, or other friction means, are arranged to act between the normally leading faces 54 of the bobbins and the opposing faces 58 of the cutouts 36 as described. This has the advantage that the pre-load of the clips is in the direction of applied braking force when the disc is braked whilst moving in the forward direction of rotation. However, the clips 60, or other friction means, could, either alternatively or additionally, be provided to act between the normally trailing faces 52 of the bobbins and the opposing faces 56 of the cutouts if required.

Although braking occurs predominantly during forward travel of a vehicle, some braking will occur when the vehicle is travelling in reverse. As described previously, when a vehicle to which the disc assembly 10 is fitted is braked when travelling in reverse, the braking forces are transferred from the rotor 12 to the hub 14 through the normally leading faces 54 of the bobbins and the opposing faces 58 of the cutouts. A particular feature of the present embodiment is that the spring clips 60 can be compressed into the recesses 62 in the bobbins when the discs are braked in reverse travel, so that the normally leading faces 54 of the bobbins 38 can come in to direct contact with the opposing faces 58 of the cutouts enabling the braking forces to be transmitted directly between the contacting faces 54, 58 rather than through the spring clips 60.

The spring clips 60 can be made of any suitable material able to retain its required properties at the maximum operating temperature of the brake disc assembly. For example, the spring clips 60 may be made from a nickle-chromium alloy which may be from the Nimonic range of alloys.

Whereas the spring clips 60 have been described as being mounted in recesses 62 formed in the normally leading face of the bobbins 38, this need not be the case. The spring clips could, for example, be mounted in recesses formed in the normally trailing faces 52 of the bobbins or could be mounted in recesses formed in one or both of the opposing faces 56, 58 of the cutouts and arranged to contact a corresponding one of the radially extending faces 52, 54 on the bobbins. Furthermore, it should be understood that the spring clips need not be D-shaped in cross section and that any suitable form of spring clip or other resilient means can be used. Indeed the friction means need not comprise a resilient means at all, for example, suitable friction materials could be applied to one or more of the radially extending faces 52, 54 of the bobbin and/or to one or more of the opposing faces 56, 58 of the cutouts.

In a brake disc assembly in accordance with the invention, the overall level of hysteresis or friction introduced into the floating rotor mechanism can be tuned to suit the requirements of any particular application. Application factors that may influence the level of hysteresis or friction required include the disc diameter and mass, deflection of the hub bearing under cornering loads, influence of the brake caliper type and general levels of refinement of the host vehicle.

In the preferred embodiment, for example, the pre-load on each of the spring clips 60 and/or the number of clips 60 provided on the disc can be varied in order to adjust the overall level of hysteresis or friction as required. Hence it may be found that for some applications satisfactory performance can be achieved if a spring clip 60, or other friction means, is provided in respect of only some, or indeed only one, of the bobbins 38. In particular, it may be that a spring clip 60, or other friction means, need only be provided on every alternate bobbin.

Whereas the invention has been described in relation to what is presently considered to be the most practical and preferred embodiments, it is to be understood that the invention is not limited to the disclosed arrangements but rather is intended to cover various modifications and equivalent constructions included within the scope of the invention as claimed. For example, the bobbins or drive members 38 could be rigidly attached to the hub member 14 and arranged to engage in cutouts in the rotor 12. Those skilled in art will also appreciate that the precise number of drive members or bobbins 38 used to connect the rotor 12 and the hub member 14 is not essential to the invention and can be varied according to requirements.

1. A brake disc assembly comprising a hub member and a rotor mounted to the hub member for rotation therewith, the rotor being capable of moving in an axial direction of the disc assembly relative to the hub member to a limited extent, at least one drive member rigidly attached to one of the rotor or the hub member and being received in a corresponding cutout in the other of the rotor or the hub member, the drive member being movable in an axial direction of the disc assembly relative to the cutout as the rotor moves axially relative to the hub member, the drive member having radially extending faces for contact with opposing faces of the corresponding cutout to transmit torque between the rotor and the hub member, characterized in that said axial movement of the rotor relative to the hub member is limited by corresponding stop means associated with the rotor and the hub member respectively and in that a friction means is provided to resist, at least initially, axial movement of the drive member relative to its corresponding cutout.

2. A brake disc assembly as claimed in claim 1, in which the friction means is operative between one of the radially extending faces of the drive member and an opposing face of the cutout.

3. A brake disc assembly as claimed in claim 2, in which the friction means is operative between a radially extending face of the drive member and an opposing face of the cutout which are adapted, in use, to transmit braking forces between the rotor and the hub when the disc assembly is braked whilst rotating in its reverse direction.

4. A brake disc assembly as claimed in claim 3, in which the friction means is operative between a normally leading face of the drive member and an opposing face of the cutout.

5. A brake disc assembly as claimed in claim 1, in which the friction means comprises a resilient means.

6. A brake disc assembly as claimed in claim 5, in which the resilient means is a spring clip.

7. A brake disc assembly as claimed in claim 6, in which the resilient means is at least partially received in a recess formed in one of the radially extending face of the drive member or an opposing face of the cutout and is adapted to contact the other of said radially extending face or said opposing face.

8. A brake disc assembly as claimed in claim 7, in which the resilient means is at least partially received in a recess formed in a radially extending face of the drive member.

9. A brake disc assembly as claimed in claim 7, in which the resilient means can be compressed into the recess to enable direct contact between said radially extending face and said opposing face when braking forces are transferred from the rotor to the hub member through said faces.

10. A brake disc assembly as claimed in claim 7, in which the recess is curved.

11. A brake disc assembly as claimed in claim 7, in which the spring clip is generally D-shaped in cross section, the curved portion being received in the recess.

12. A brake disc assembly as claimed in claim 11, in which the spring clip is split at the apex of the D.

13. A brake disc assembly as claimed in claim 5, in which the resilient means applies a pre-load acting in the direction of the applied braking force when the disc assembly is braked whilst rotating in its forward direction.

14. A brake disc assembly as claimed in claim 1, in which there are a plurality of circumferentially spaced drive members, a friction means being provided in respect of at least one of the drive members.

15. A brake disc assembly as claimed in claim 13, in which the number of friction means provided on the disc assembly is selected such that the overall level of hysteresis introduced into the floating rotor mechanism is adapted to suit the particular application.

16. A brake disc assembly as claimed in claim 1, in which the friction means is arranged to provide a pre-determined level of friction between the drive member and the cutout.

17. (canceled)
